(19) United States
(12) Patent Application Publication
(10) Pub. No.: US 2025/0054214 A1
(43) Pub. Date: Feb. 13, 2025

(54) INFORMATION PROCESSING APPARATUS, LAYOUT ASSISTANCE METHOD, AND STORAGE MEDIUM

(71) Applicant: NEC Corporation, Minato-ku, Tokyo (JP)

(72) Inventors: Ichiro IGURA, Tokyo (JP); Naoki KATOH, Tokyo (JP); Takahiro TOIZUMI, Tokyo (JP); Akiyuki ISHIYAMA, Tokyo (JP); Yasuhiko AWASAWA, Tokyo (JP)

(73) Assignee: NEC Corporation, Minato-ku, Tokyo (JP)

(21) Appl. No.: 18/721,962

(22) PCT Filed: Dec. 24, 2021
(86) PCT No.: PCT/JP2021/048078

§ 371 Date: Jun. 20, 2024

(51) Int. Cl. G06T 11/60; G06T 3/40; G06V 30/414

(52) U.S. Cl. CPC G06T 11/60; G06T 3/40; G06V 30/414

(57) ABSTRACT

To make it possible to automatically carry out all processes from determination of an assignment area for each article to determination of a layout of constituent elements of the article in the assignment area, provided is an information processing apparatus (1) includes: an area determination section (11) that determines an assignment area for each of a plurality of articles in an object area in which the articles are placed; and an element layout determination section (12) that determines a layout of constituent elements of the article in the assignment area.

### TECHNICAL FIELD

The present invention relates to an information processing apparatus and the like for assisting in generating the layouts for placing articles on, for example, newspapers and magazines for print pages or for web pages.

### BACKGROUND ART

Laying out articles on print pages of newspapers, magazines, and the like, has conventionally been performed manually, and a technique for saving labor and improving efficiency of such an operation is required. One such technique is, for example, an organizing and compositing apparatus disclosed in Patent Literature 1 below. This organizing and compositing apparatus displays a rough layout that indicates a layout of news frames on a newspaper page and accepts an operator's layout designation, to facilitate generating or changing the rough layout.

### CITATION LIST

### Patent Literature

### [Patent Literature 1]

Japanese Patent Application Publication Tokukaihei No. 11-154239

### SUMMARY OF INVENTION

### Technical Problem

However, the organizing and compositing apparatus disclosed in Patent Literature 1 merely allows an operation that has been conventionally carried out on an assignment sheet to be carried out on a screen, so that it is necessary to manually determine assignment areas of news articles, and a layout of a headline, a photo, and any other item in each assignment area.

An example aspect of the present invention has been made in view of this problem, and an example object thereof is to provide a technique that makes it to possible to automatically carry out all processes from determination of an assignment area for each article to determination of a layout of constituent elements of the article in the assignment area.

### Solution to Problem

An information processing apparatus in accordance with an example aspect of the present invention includes: area determination means for determining an assignment area for each of a plurality of articles in an object area in which the articles are placed; and element layout determination means for determining a layout of constituent elements of the article in the assignment area.

A layout assistance method in accordance with an example aspect of the present invention includes: determining an assignment area for each of a plurality of articles in an object area in which the articles are placed by at least one processor; and determining a layout of constituent elements of the article in the assignment area by the at least one processor.

A layout assistance program in accordance with an example aspect of the present invention causes a computer to function as: area determination means for determining an assignment area for each of a plurality of articles in an object area in which the articles are placed; and element layout determination means for determining a layout of constituent elements of the article in the assignment area.

### Advantageous Effects of Invention

According to an example aspect of the present invention, it is possible to automatically carry out all processes from determination of an assignment area for each article to determination of a layout of constituent elements of the article in the assignment area.

### BRIEF DESCRIPTION OF DRAWINGS

FIG. 1 is a block diagram illustrating the configuration of an information processing apparatus in accordance with a first example embodiment of the present invention.

FIG. 2 is a flowchart illustrating the flow of a layout assistance method in accordance with the first example embodiment of the present invention.

FIG. 3 is a block diagram illustrating the configuration of an information processing apparatus in accordance with a second example embodiment of the present invention.

FIG. 4 is a diagram illustrating a screen example displaying a layout result generated by the information processing apparatus illustrated in FIG. 3.

FIG. 5 is a diagram illustrating an example of an adjustment made to assignment areas.

FIG. 6 is a flowchart illustrating the flow of a layout assistance method in accordance with the second example embodiment of the present invention.

FIG. 7 is a diagram illustrating an example of a computer that executes instructions of a program which is software implementing the functions of the apparatuses in accordance with the example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

### (Configuration of Information Processing Apparatus)

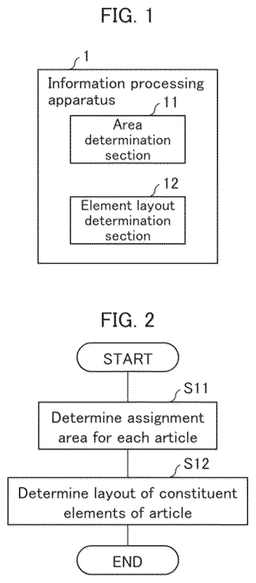

The following description will discuss the configuration of an information processing apparatus 1 in accordance with the present example embodiment with reference to FIG. 1. FIG. 1 is a block diagram illustrating the configuration of the information processing apparatus 1. As illustrated in FIG. 1, the information processing apparatus 1 includes an area determination section 11 (area determination means) and an element layout determination section 12 (element layout determination means).

The area determination section 11 determines an assignment area for each of a plurality of articles in an object area in which the articles are placed. The element layout determination section 12 determines a layout of constituent elements of the article in the assignment area.

As described in the foregoing, the information processing apparatus 1 in accordance with the present example embodiment employs a configuration of including: the area determination section 11 that determines an assignment area for each of a plurality of articles in an object area in which the articles are placed; and the element layout determination section 12 that determines a layout of constituent elements of the article in the assignment area.

According to this configuration, it is possible to automatically carry out all processes from determination of an assignment area for each article to determination of a layout of constituent elements of the article in the assignment area.

### (Layout Assistance Program)

The abovementioned functions of the information processing apparatus 1 may be implemented by a program. An assistance program in accordance with the present example embodiment causes a computer to function as: area determination means for determining an assignment area for each of a plurality of articles in an object area in which the articles are placed; and element layout determination means for determining a layout of constituent elements of the article in the assignment area. According to this assistance program, it is possible to automatically carry out all processes from determination of an assignment area for each article to determination of a layout of constituent elements of the article in the assignment area.

### (Flow of Layout Assistance Method)

The following description will discuss the flow of a layout assistance method in accordance with the present example embodiment with reference to FIG. 2. FIG. 2 is a flowchart illustrating the flow of the layout assistance method. It should be noted that steps of the assistance method may be carried out by a processor of the information processing apparatus 1 or by a processor of another apparatus. Alternatively, the steps may be carried out by processors provided in respective different apparatuses.

In S11, at least one processor determines an assignment area for each of a plurality of articles in an object area in which the articles are placed.

In S12, the at least one processor determines a layout of constituent elements of the article in the assignment area.

As described in the foregoing, the layout assistance method in accordance with the present example embodiment includes: determining an assignment area for each of a plurality of articles in an object area in which the articles are placed by at least one processor (S11); and determining a layout of constituent elements of the article in the assignment area by the at least one processor (S12). According to this assistance method, it is possible to automatically carry out all processes from determination of an assignment area for each article to determination of a layout of constituent elements of the article in the assignment area.

### Second Example Embodiment

The following description will discuss a second example embodiment of the present invention in detail with reference to the drawings.

### (Configuration of Information Processing Apparatus)

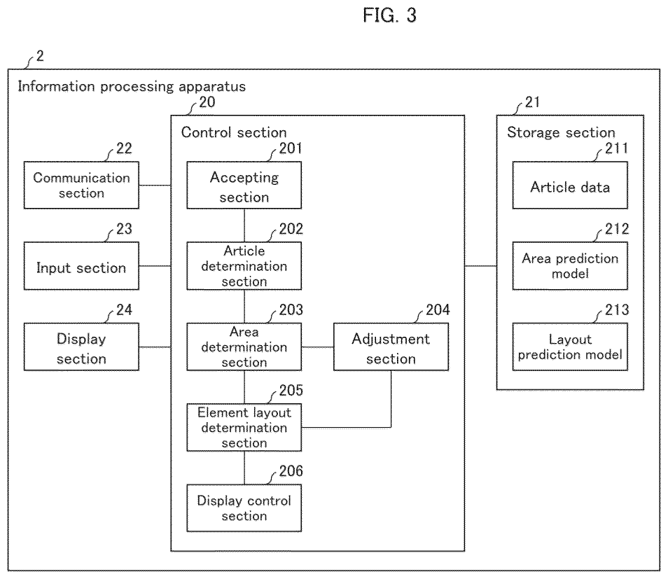

The following description will discuss the configuration of an information processing apparatus 2 in accordance with the present example embodiment with reference to FIG. 3. FIG. 3 is a block diagram illustrating the configuration of the information processing apparatus 2. As illustrated in the figure, the information processing apparatus 2 includes: a control section 20 that centrally controls each section of the information processing apparatus 2; and a storage section 21 that is a storage device configured to store various data used by the information processing apparatus 2. The information processing apparatus 2 also includes: a communication section 22 configured to allow communication between the information processing apparatus 2 and other apparatuses; an input section 23 that accepts a user's input operation to the information processing apparatus 2; and a display section 24 that is a display device configured to display an image.

The control section 20 includes an accepting section 201, an article determination section 202, an area determination section (area determination means) 203, an adjustment section (adjustment means) 204, an element layout determination section (element layout determination means) 205, and a display control section 206. The storage section 21 stores therein article data 211, an area prediction model 212, and a layout prediction model 213. The adjustment section 204 will be described under “(Adjustment of assignment area)”.

The accepting section 201 accepts input of information indicating an article to be placed in an object area (e.g., print pages or web pages of newspapers or magazines) and various kinds of information associated with the article, and the accepting section 201 stores the input in the storage section 21 as the article data 211. The various kinds of information may be inputted via, for example, the input section 23, or alternatively, may be inputted from another apparatus via the communication section 22.

The article data 211 includes information indicating each article to be placed, and includes various information associated with each article. More particularly, the article data 211 includes information indicating the constituent elements of an article, such as the text of each article, a photo included in each article, and the headline of each article. As the information associated with these constituent elements, the article data 211 may include information indicating the contents, theme, size, or volume (e.g., in a case of text, the number of characters, the number of characters per line, the number of lines, etc.) of each constituent element.

The article determination section 202 determines an article to be placed in the object area from among articles indicated in the article data 211. For example, when the article data 211 includes information indicating the importance of each article, the article determination section 202 may determine the article to be placed based on the importance. Further, for example, the article determination section 202 may determine an article selected by a user as the article to be placed in the object area. The settings of the importance will be described under “(Settings of importance and group)”.

The area determination section 203 determines an assignment area for each of a plurality of articles in the object area in which the articles are placed. This process corresponds to the preparation of a makeup layout in a newspaper or the like. Any of various methods of determining an assignment area for each article may be employed. For example, the area determination section 203 may determine an assignment area for each article by using the area prediction model 212.

The area prediction model 212 is a model for determining an assignment area of an article, the model being generated by performing machine learning based on a relationship between (i) various kinds of information associated with the layout of articles, serving as an explanatory variable, and (ii) information indicating an assignment area of an article, serving as an objective variable. The area prediction model 212 may be prepared for each type of an object page on which articles are placed. For example, in a case where the object page is a print page of a newspaper, the determination of assignment areas of articles on the general news page may be made by using an area prediction model which is generated by performing machine learning using layouts of articles on general news pages, and the determination of assignment areas of articles on the local news page may be made by using an area prediction model which is generated by performing machine learning using layouts of articles on local news pages. In this way, by preparing area prediction models for respective object page types and by using a corresponding one of the area prediction models in accordance with the object page types, it is possible to determine assignment areas suitable for any object page types.

As the explanatory variable, information associated with the constituent elements of each article may be used. For example, information indicating the size of an object area in which an article is to be placed (coordinate values at four corners, or width and height), the contents, size, and volume of the text of an article, a photo included in an article, the headline, and the like may be used as the explanatory variable. Further, information indicating the category or the importance of an article may be included in the explanatory variable. These pieces of information about an article to be placed may be included in the article data 211. The abovementioned objective variable may be information indicating the position and range of each article in an object area in which the articles are placed. For example, the position coordinates indicating the positions of the four corners of each article in the object area may be used as the objective variable, or alternatively, information indicating the representative coordinates of each article in the object area and the width and height of the article may be used as the objective variable.

The area determination section 203 may determine an assignment area for each article in accordance with any other technique. For example, the area determination section 203 may determine an assignment area for each article in accordance with a predetermined rule such as arranging articles in order of importance, or alternatively, may determine an assignment area in accordance with a user's operation. The area determination section 203 may determine an assignment area for each article by using two or more techniques. In this case, the user may be made to select an area to be adopted from among assignment areas determined by the respective techniques.

The element layout determination section 205 determines, for each assignment area determined by the area determination section 203, a layout of constituent elements of the article. This process corresponds to the preparation of a local layout in a newspaper or the like. Similarly to the method of determining an assignment area for each article, various methods of determining a layout of constituent elements may be employed. For example, the element layout determination section 205 may determine a layout of constituent elements by using the layout prediction model 213.

The layout prediction model 213 is a model for determining a layout of constituent elements of an article, the model being generated by performing machine learning based on a relationship between (i) various kinds of information associated with a layout of constituent elements of an article, serving as an explanatory variable, and (ii) information indicating a layout of constituent elements of an article, serving as an objective variable.

It is desirable that the explanatory variable include at least the shape and size of an assignment area in which the constituent elements are placed. For example, the coordinates or the width and height of the four corners of an article may be used as the explanatory variable. Further, the explanatory variable may include information indicating the contents, size, and volume of each constituent element (e.g., the text, a photo, the headline, etc.) included in an article. Alternatively, for example, information indicating the category or the importance of an article may be included in the explanatory variable. These pieces of information may be included in the article data 211. The abovementioned objective variable may be information indicating the position and range of each constituent element in an assignment area. For example, information indicating position coordinates or the like indicating the positions of the four corners of each constituent element of an article may be used as the objective variable.

As described in the foregoing, the element layout determination section 205 may determine the layout of the constituent elements by using the layout prediction model 213 generated by performing machine learning based on a relationship between (i) a shape and a size of an assignment area, and (ii) a layout of constituent elements of an article placed in the assignment area of the shape and the size. This achieves an example advantage of making it possible to determine an appropriate layout of the constituent elements in accordance with the shape and size of the assignment area, in addition to the example advantage achieved by the information processing apparatus 1 in accordance with the first example embodiment. For example, the display control section 206 carries out control for causing a display device to display an image. The display device may be the display section 24 included in the information processing apparatus 2, or alternatively, may be another display device connected to the information processing apparatus 2 by wired or wireless communication. For example, the display control section 206 causes the display section 24 to display a preview image that indicates the determination result of the assignment area for each article obtained by the area determination section 203 and the determination result of the layout of the constituent elements of the article in the assignment area obtained by the element layout determination section 205 (hereinafter also referred to as “layout result”). The preview image will be described under “(Screen example)”.

### (Settings of Importance and Group)

As described above, the importance may be set for each article to be placed. The importance is information indicating how important an article is. The importance only needs to be a degree that allows comparison of importance between articles. For example, the importance may be expressed by a numerical value such as a numerical value ranging from 0 up to 100 with the maximum score of 100, or alternatively, may be expressed in scales such as on a scale from A for important, B for moderately important, and C for less important. It is desirable that the more important the article is, the more conspicuous position the article be placed in, so that the importance can be referred to in determining an assignment area for each article. The importance of an article can also be referred to as the priority of placing the article in a conspicuous position. For example, in a case of newspapers, since the importance of each article is determined by an editorial conference, the user may set the importance determined in the editorial conference. This enables a person who does not participate in the editorial conference to determine assignment areas in accordance with the importance determined in the editorial conference.

It is preferable that the importance of each article be freely set and changed by the user. The method of setting and changing the importance is not particularly limited. For example, the display control section 206 may cause the display section 24 to display the settings screen for setting the importance of each article to be placed. In this case, the accepting section 201 accepts the setting operation of the importance performed on the settings screen, and stores the importance of each article in the article data 211 in accordance with the setting operation.

Further, grouping of articles to be placed may be allowed. In this case, the area determination section 203 handles the grouped articles as one article. Thus allows related articles to be grouped and displayed in one collective assignment area. Similarly to the importance, it is also preferable that the grouping be freely set and changed by the user. For example, the display control section 206 may cause the display section 24 to display a list of articles, and the accepting section 201 may accept the grouping setting of articles and store the setting in the article data 211.

### (Screen Example)

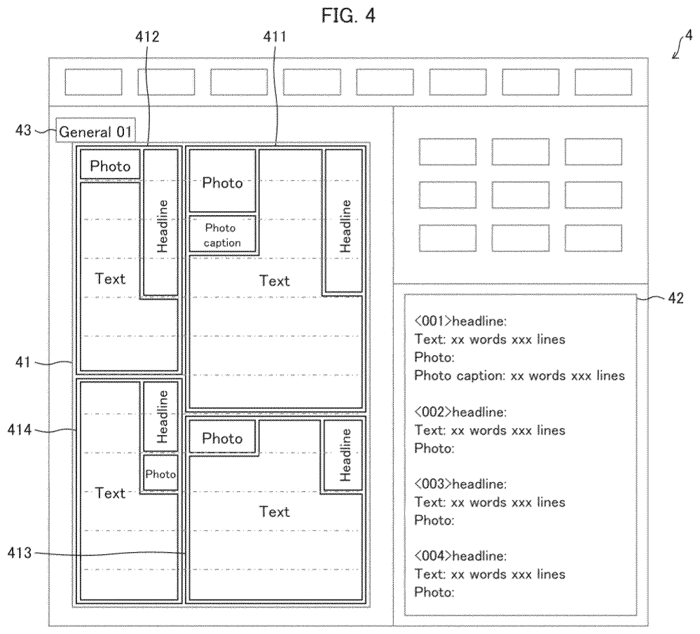

FIG. 4 is a diagram illustrating a screen example displaying a layout result generated by the information processing apparatus 2 (more particularly, by the area determination section 203 and the element layout determination section 205). The screen 4 illustrated in FIG. 4 includes a preview area 41, an article list display area 42, and an object area information display area 43.

The preview area 41 is an area for displaying a layout result. In the preview area 41, displayed is a preview image in which articles are arranged in the respective assignment areas determined by the area determination section 203, and the constituent elements of each article are arranged in accordance with a layout determined by the element layout determination section 205. It is only required that the user of the information processing apparatus 2 simply input various kinds of information associated with each article to be placed and its constituent elements, and the importance of each article, into the information processing apparatus 2, to cause the information processing apparatus 2 to automatically generate a layout and to display the result as such a preview image.

The preview area 41 illustrated in FIG. 4 displays rectangles 411 to 414. The rectangles 411 to 414 indicate assignment areas of articles having the identification information of <001> to <004>, respectively. These assignment areas are those determined by the area determination section 203. Here, the dash-dot lines in the preview area 41 indicate a column setting of article text.

Inside each of the rectangles 411 to 414, the constituent elements of the corresponding article are placed. For example, inside the rectangle 411, placed are the constituent elements of the article which has the identification information of <001>, that is, the “headline”, the “text”, a “photo”, and a “photo caption” (caption of the photo). Here, a character string of a real headline may be displayed in the “headline” area in FIG. 4. Similarly, in the “text” area and the “photo caption” area, the text thereof may be displayed, and in the “photo” area, the photo may be displayed.

The article list display area 42 is an area for displaying a list of articles to be placed. In the article list display area 42 of FIG. 4, four articles having the identification information of <001> to <004> are listed. These articles are those placed in the preview area 41. Further, in the article list display area 42, information indicating the constituent elements of each article is described as the information associated with the article. For example, with regard to the article having the identification information of <001>, the constituent elements of the article are listed. Specifically, the headline, the text, a photo, and a photo caption are displayed as the constituent elements. With regard to the text, its volume is also displayed (more specifically, the number of characters per line and the number of lines).

The article list display area 42 only needs to display information such that the user can recognize what kind of article each article is, and the information to be displayed is not limited to that illustrated in FIG. 4. Further, in the article list display area 42, the identification information of each article (e.g., article ID, headline, etc.) may be listed, to allow the user to select the identification information to view the details of the article. For example, when one of the pieces of the identification information of articles displayed in the article list display area 42 is designated, the display control section 206 may display a pop-up showing the detailed information (e.g., the constituent elements of the article etc.) of the article corresponding to the designated piece of the identification information.

The object area information display area 43 is an area for displaying object area information that is information associated with the object area in which the articles are placed. The object area information display area 43 of FIG. 4 displays the object area information indicating that the object area in which the articles are placed is the general news page (front page) of the newspaper. In this way, the object area information may indicate the type of the object area. The object area information only needs to be information associated with the object area in which the articles are placed, and is not limited to the example of FIG. 4.

### (Adjustment of Assignment Area)

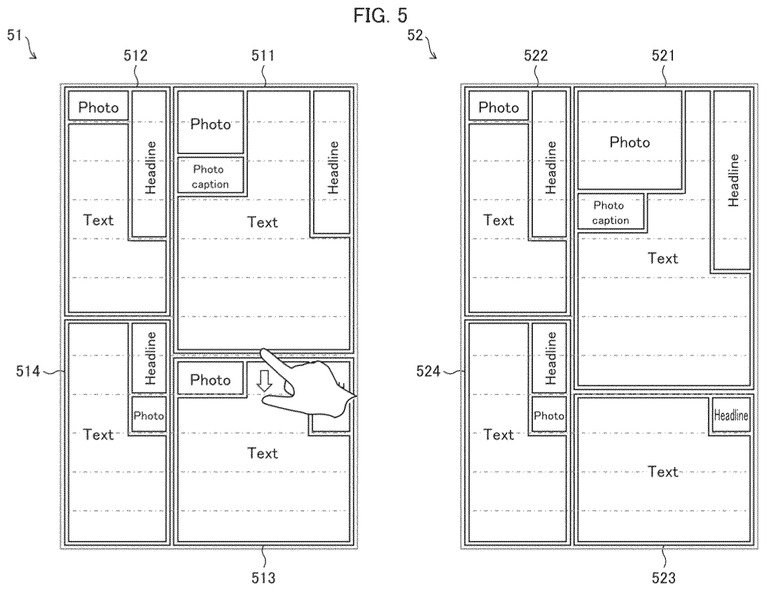

The assignment area determined by the area determination section 203 may be resized by the user. However, resizing the assignment area by the user may result in an overflow of the constituent elements of the article assigned to the resized assignment area, or may leave a blank in the assignment area. In such a case, the adjustment section 204 resizes or deletes at least one of the constituent elements of the article placed in the assignment area so that the article confirms in size to the assignment area. This will be described with reference to FIG. 5. FIG. 5 is a diagram illustrating an example of an adjustment made to assignment areas.

FIG. 5 illustrates preview images 51 and 52, which are displayed in the preview area described above. Of these, the preview image 51 includes four rectangles 511 to 514. The user performs a resizing operation of the assignment area with respect to the preview image 51. Specifically, the user performs an operation to drag a boundary between the rectangles 511 and 513 downward. Of course, any kind of operation may be employed in resizing the assignment area, and the operation is not limited to this example.

The above operation is performed by expanding the assignment area corresponding to the rectangle 511 by stretching it downward. When the accepting section 201 accepts this operation, the adjustment section 204 expands or contracts the assignment areas subjected to the operation in accordance with the manipulated variable of the operation, that is, the dragging distance. In the example of FIG. 5, since the boundary between the rectangles 511 and 513 are pulled downward by one column, the adjustment section 204 expands the assignment area of the article corresponding to the rectangle 511 by one column downward, and contracts the assignment area of the article corresponding to the rectangle 513 by one step downward.

Next, as for the expanded assignment area, the adjustment section 204 distributes the increased area to one or both of the headline and the photo. Thus, it is possible to enlarge one or both of the photo and the headline without changing the total area of the display area of text, such as the article text and the photo caption. The priorities of enlargement may be assigned to the headline and the photo in advance, or alternatively, may be selected by the user. Of course, any constituent element other than the photo and the headline (e.g., an illustration, a diagram, etc.) may be enlarged. The same applies to the contraction described below.

Further, as for the contracted assignment area, the adjustment section 204 compares the decreased area with the acceptable minimum areas of the headline and the photo (hereinafter, referred to as “acceptable minimum areas”). The acceptable minimum area may be set in advance. When the decreased area is not more than the acceptable minimum area, the adjustment section 204 reduces in size either or both of the photo and the headline in a range in which both the area photo and the headline becomes not less than the acceptable minimum areas. The priorities of size reduction may be assigned to the headline and the photo in advance, or alternatively, may be selected by the user. On the other hand, when the decreased area is more than the acceptable minimum areas, the adjustment section 204 determines to delete the photo, and then if the deletion of the photo cannot compensate for the decrease in area, then the headline is reduced in size to compensate for the insufficient area. When deleting the photo, the adjustment section 204 also deletes any constituent element associated with the photo, such as the caption of the photo. If the total area of the constituent elements to be deleted exceeds the decreased area, the adjustment section 204 may expand the area of a constituent element such as the headline to compensate for the difference therebetween.

In the preview image 52 of FIG. 5, rectangle 521, which corresponds to the rectangle 511, has a size increased by expanding the rectangle 511 downward by one column by the adjustment performed by the adjustment section 204. Among the constituent elements present inside the rectangle 521, the sizes of the photo and the headline are increased. In addition, rectangle 523, which corresponds to the rectangle 513, has a size decreased by contracting the rectangle 513 downward by one column. Then, among the constituent elements present inside the rectangle 523, the photo is deleted and the size of the headline is reduced.

Here, the accepting section 201 may accept any resizing operation of the constituent elements of an article such as the photo and the headline. In this case, the adjustment section 204 may resize another constituent element of the article, so that every constituent element fits within the assignment area without changing the size of the assignment area. Further, the adjustment section 204 may resize the assignment area of the article so that the resized constituent element fits therewithin, and resize another assignment area adjacent to the assignment area. In this case, the adjustment section 204 resizes or deletes the constituent elements present inside the adjacent assignment area in a manner similar to that described above.

As described in the foregoing, the adjustment section 204 resizes or deletes at least one of the constituent elements of an article placed in the assignment area so that the article confirms in size to the assignment area. With this configuration, in addition to the example advantage achieved by the information processing apparatus 1 in accordance with the first example embodiment, it is possible to achieve an example advantage of being capable of automatically obtaining the article with the constituent elements that have confirmed in size to the resized assignment area even when the assignment area of the article is resized by the user. It is preferable that a constituent element to be enlarged or reduced be a constituent element other than sentences, that is, for example, the headline and the photo described above. However, if there is no problem even if the interline or the character size changes for each assignment area, sentences may be subject to the enlargement or reduction.

### (Flow of Layout Assistance Method)

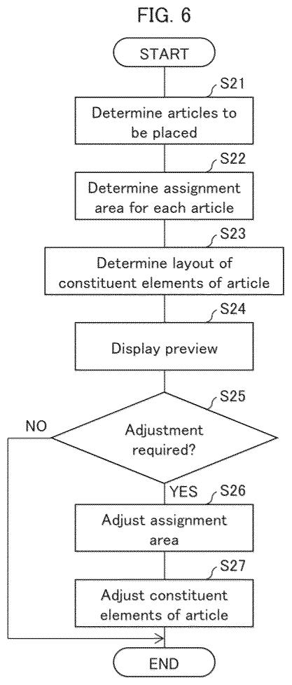

The following description will discuss the flow of a layout assistance method in accordance with the present example embodiment with reference to FIG. 6. FIG. 6 is a flowchart illustrating the flow of the layout assistance method. FIG. 6 illustrates processes after each article that is a candidate to be placed has been recorded as the article data 211, and the setting of importance and group has been completed as necessary.

In S21, the article determination section 202 determines a plurality of articles to be placed in the object area from among articles indicated in the article data 211. For example, as the articles to be placed in the object area, the article determination section 202 may determine, from among the articles indicated in the article data 211, a plurality of articles such that each of the articles has a greater importance and the sum of the areas required to place those articles is not more than the area of the object area. For example, as the articles to be placed in the object area, the article determination section 202 may determine an article or articles designated by the user via, for example, the input section 23.

In S22, for each article determined to be placed in S21, the area determination section 203 determines an assignment area in the object area. For example, the area determination section 203 may determine the assignment area for each article in accordance with an output value obtained by inputting, into the area prediction model 212, various kinds of information associated with a layout of each article determined to be placed in S21 (e.g., the size of the object area, the constituent elements of each article, the importance, etc.).

In S23, for each candidate area determined on placement in S22, the element layout determination section 205 determines the layout of the constituent elements of the article. For example, the element layout determination section 205 may determine the layout of the constituent elements in the assignment area in accordance with the output value obtained by inputting, into the layout prediction model 213, various kinds of information associated with the assignment area determined in S22 (e.g., the size, the shape of assignment area, the size of each constituent element of the article to be placed, etc.). It should be noted that this process is carried out for each assignment area determined on placement in S22.

In S24, the display control section 206 causes the display section 24 to display a preview image indicating the determination results obtained in S22 and S23. The preview image is an image showing that the articles are placed in the respective assignment areas determined in S22 and the constituent elements are placed in those assignment areas in accordance with the layouts determined in S23.

In S25, the accepting section 201 determines whether or not to adjust the assignment areas shown in the preview image. When it is determined to perform adjustment (YES in S25), the process proceeds to S26. On the other hand, when it is determined to perform no adjustment (NO in S25), the accepting section 201 stores the determination results obtained in S22 and S23 in the storage section 21 and terminates the routine. The method of determining whether or not the adjustment is required is not particularly limited. For example, the accepting section 201 may determine to perform adjustment when an operation of changing an assignment area as described above with reference to FIG. 5 is detected, and may determine to perform no adjustment when an operation for finalizing the layout with the contents of the preview image is detected.

In S26, the adjustment section 204 adjusts an assignment area according to a user's changing operation. It should be noted that although an adjustment accompanied by expanding or contracting of assignment area is assumed here, an adjustment may be performed such that the height and the width of the assignment area are changed without changing the area thereof. In this case, the process in S27 is not necessary. Instead, in accordance with the change in height and width of the assignment area, the element layout determination section 205 may re-determine the layout of the constituent elements therein.

In S27, the adjustment section 204 adjusts the constituent elements of the article placed in the assignment area in such a manner as to fit within the assignment area adjusted by the process in S26. More specifically, the adjustment section 204 resizes or deletes at least one of the constituent elements of the article placed in each assignment area so that the article confirms in size to the assignment area. After completion of S27, the adjustment section 204 stores the assignment areas after adjustment and the layout of the constituent elements in each assignment area after adjustment in the storage section 21, and terminates the routine.

### (Generation of Multiple Candidates)

The area determination section 203 may first generate a plurality of candidates of assignment areas in determining the assignment area of each article in S22 of FIG. 6. For example, the area determination section 203 may generate some candidates by using the area prediction model 212 and additional candidates by using any other method, or alternatively, the area determination section 203 may generate a plurality of candidates by using two or more area prediction models 212. As the two or more area prediction models 212, it is sufficient to use models that differ in any one of the explanatory variable and the training data used in model construction. Any method of determining one candidate to be adopted from among the candidates may be used; for example, the area determination section 203 may make a determination based on an input operation performed by a user of the information processing apparatus 2. Thus, it is possible to determine assignment areas as intended by the user.

Similarly, in determining the layout of the constituent elements of the article in S23 of FIG. 6, the element layout determination section 205 may generate a plurality of candidates of the layout of the constituent elements for each assignment area. For example, the element layout determination section 205 may generate some candidates by using the layout prediction model 213 and additional candidates by using any other method, or alternatively, the element layout determination section 205 may generate a plurality of candidates by using two or more layout prediction model 213. As the two or more layout prediction model 213, it is sufficient to use models that differ in any one of the explanatory variable and the training data used in model construction. Any method of determining one candidate to be adopted from among the candidates may be used; for example, the element layout determination section 205 may make a determination based on an input operation performed by a user of the information processing apparatus 2. With this configuration, it is possible to achieve an example advantage of being capable of determining the layout of the constituent elements as intended by a user, in addition to the example advantage achieved by the information processing apparatus 1 in accordance with the first example embodiment.

### (Constituent Element Layout in Consideration of Position of Assignment Area)

The element layout determination section 205 may determine the layout of the constituent elements in accordance with the position of the assignment area in the object area. With this configuration, it is possible to achieve an example advantage of being capable of determining the appropriate layout of the constituent elements in accordance with the position of the assignment area in the object area, in addition to the example advantage achieved by the information processing apparatus 1 in accordance with the first example embodiment.

For example, a rule may be determined in advance that a candidate in which the headline is placed to be closer to the outer periphery of the object area is given a higher priority. In this case, in accordance with this rule, the element layout determination section 205 can adopt a candidate in which the headline is placed to be closer to the outer periphery of the object area, from among the candidates generated as described above.

Further, for example, the element layout determination section 205 may determine the layout of the constituent elements by revising the layout generated by using the layout prediction model 213 in accordance with the position of the assignment area in the object area. For example, by determining in advance a rule that the headline should be placed to be closer to the outer periphery of the object area, the element layout determination section 205 can revise the layout generated by using the layout prediction model 213 in accordance with this rule, so as to place all headlines in all candidate areas to be closer to the outer periphery of the object area.

The method of determining the layout in accordance with to the position of the assignment area in the object area is not limited to the foregoing method. For example, the element layout determination section 205 may determine the layout of the constituent elements by using a layout prediction model generated by performing machine learning based on a relationship between (i) the position, the shape, and the size of an assignment area in the object area, and (ii) the layout of constituent elements of an article placed in the assignment area of the position, the shape, and the size.

With this configuration, the position of the assignment area in the object area is taken into consideration in prediction of the layout prediction model. Thus, it is possible to achieve an example advantage of being capable of determining the appropriate layout of the constituent elements in accordance with the position of the assignment area in the object area, as well as the shape and the size of the assignment area, in addition to the example advantage achieved by the information processing apparatus 1 in accordance with the first example embodiment. For example, it is also possible to determine a layout that reflects, for example, the following tendencies: in an assignment area at the upper right end of the page, the headline is often placed at the upper right end of the page, and in an assignment area placed at the upper end of the page, the headline is often placed at the upper end of the page.

### [Variations]

Any subject may carry out each process described in the above example embodiments, and is not limited to the examples described above. In other words, it is possible to construct a layout assistance system having the same functions as those of the information processing apparatuses 1 and 2 with use of a plurality of apparatuses capable of mutual communication. For example, a layout assistance system having the same functions as those of the information processing apparatus 2 can be constructed by dispersedly providing, in a plurality of apparatuses, respective blocks illustrated in FIG. 3.

For example, among the process blocks included in the control section 20 illustrated in FIG. 3, all the process blocks except for the accepting section 201 and the display control section 206 may be provided in a cloud server. In this case, the information processing apparatus 2 only needs to send the article data 211 or various kinds of data underlying the article data 211 to the cloud server to lay out articles thereof. Then, the information processing apparatus 2 only needs to obtain the layout result from the cloud server, and displays a preview image or records the result. Even in such a configuration, it is possible to automatically carry out all processes from determination of an assignment area for each article to determination of a layout of constituent elements of the article in the assignment area.

### [Software Implementation Example]

Some or all of the functions of the information processing apparatus 2 may be implemented by hardware such as an integrated circuit (IC chip), or may be alternatively implemented by software.

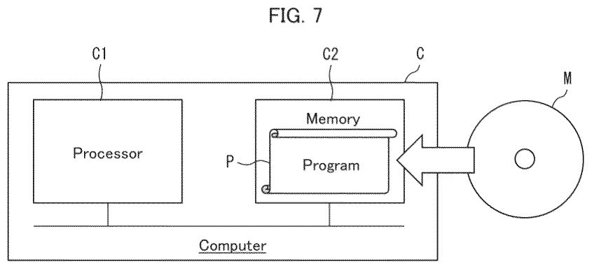

In the latter case, the information processing apparatus 2 is implemented by, for example, a computer that executes instructions of a program (assistance program) that is software implementing the foregoing functions. FIG. 7 illustrates an example of such a computer (hereinafter, referred to as “computer C”). The computer C includes at least one processor C1 and at least one memory C2. The memory C2 stores a program P for causing the computer C to operate as the information processing apparatus 2. The processor C1 of the computer C retrieves the program P from the memory C2 and executes the program P, so that the functions of the information processing apparatus 2 are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C may further include a communication interface via which data is transmitted to and received from another apparatus. The computer C can further include an input/output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following supplementary notes.

### (Supplementary Note 1)

An information processing apparatus including: area determination means for determining an assignment area for each of a plurality of articles in an object area in which the articles are placed; and element layout determination means for determining a layout of constituent elements of the article in the assignment area.

### (Supplementary Note 2)

The information processing apparatus according to Supplementary note 1, wherein the element layout determination means determines the layout of the constituent elements by using a layout prediction model generated by performing machine learning based on a relationship between (i) a shape and a size of an assignment area, and (ii) a layout of constituent elements of an article placed in the assignment area of the shape and the size.

### (Supplementary Note 3)

The information processing apparatus according to Supplementary note 1, wherein the element layout determination means determines the layout of the constituent elements by using a layout prediction model generated by performing machine learning based on a relationship between (i) a position, a shape, and a size of an assignment area in the object area, and (ii) a layout of constituent elements of an article placed in the assignment area of the position, the shape, and the size.

### (Supplementary Note 4)

The information processing apparatus according to any one of Supplementary notes 1 to 3, wherein the element layout determination means generates a plurality of candidates of the layout of the constituent elements for each of the assignment areas, and determines one candidate from among the candidates as the layout of the constituent elements of the assignment area, based on an input operation of a user of the information processing apparatus.

### (Supplementary Note 5)

The information processing apparatus according to Supplementary note 1 or 2, wherein the element layout determination means determines the layout of the constituent elements in accordance with a position of the assignment area in the object area.

### (Supplementary Note 6)

The information processing apparatus according to any one of Supplementary notes 1 to 5, further including adjustment means for resizing or deleting at least one of the constituent elements of the article placed in the assignment area so that the article conforms in size to the assignment area.

### (Supplementary Note 7)

A layout assistance method including: determining an assignment area for each of a plurality of articles in an object area in which the articles are placed by at least one processor; and determining a layout of constituent elements of the article in the assignment area by the at least one processor.

### (Supplementary Note 8)

A layout assistance program causing a computer to function as: area determination means for determining an assignment area for each of a plurality of articles in an object area in which the articles are placed; and element layout determination means for determining a layout of constituent elements of the article in the assignment area.

### [Additional Remark 3]

Furthermore, some of or all of the above example embodiments can also be expressed as below. An information processing apparatus including at least one processor, the at least one processor carrying out: an area determination process of determining an assignment area for each of a plurality of articles in an object area in which the articles are placed; and an element layout determination process of determining a layout of constituent elements of the article in the assignment area.

Note that the information processing apparatus may further include a memory, which may store therein a program for causing the at least one processor to carry out the area determination process and the element layout determination process. Alternatively, the program may be stored in a computer-readable, non-transitory, tangible storage medium.

### REFERENCE SIGNS LIST

1,2 Information processing apparatus
11, 203 Area determination section (area determination means)
12, 205 Element layout determination section (element layout determination means)
20 Control section
21 Storage section
22 Communication section
23 Input section
24 Display section
201 Accepting section
202 Article determination section
206 Display control section
204 Adjustment section (adjustment means)
212 Area prediction model
213 Layout prediction model

What is claimed is:

1. An information processing apparatus comprising at least one processor, the at least one processor carrying out:
an area determination process of determining an assignment area for each of a plurality of articles in an object area in which the articles are placed; and
an element layout determination process of determining a layout of constituent elements of the article in the assignment area.

2. The information processing apparatus according to claim 1, wherein, in the element layout determination process, the at least one processor determines the layout of the constituent elements by using a layout prediction model generated by performing machine learning based on a relationship between (i) a shape and a size of an assignment area, and (ii) a layout of constituent elements of an article placed in the assignment area of the shape and the size.

3. The information processing apparatus according to claim 1, wherein, in the element layout determination process, the at least one processor determines the layout of the constituent elements by using a layout prediction model generated by performing machine learning based on a relationship between (i) a position, a shape, and a size of an assignment area in the object area, and (ii) a layout of constituent elements of an article placed in the assignment area of the position, the shape, and the size.

4. The information processing apparatus according to claim 1, wherein, in the element layout determination process, the at least one processor generates a plurality of candidates of the layout of the constituent elements for each of the assignment areas, and determines one candidate from among the candidates as the layout of the constituent elements of the assignment area, based on an input operation of a user of the information processing apparatus.

5. The information processing apparatus according to claim 1, wherein, in the element layout determination process, the at least one processor determines the layout of the constituent elements in accordance with a position of the assignment area in the object area.

6. The information processing apparatus according to claim 1, wherein the at least one processor further carries out an adjustment process of resizing or deleting at least one of the constituent elements of the article placed in the assignment area so that the article conforms in size to the assignment area.

7. A layout assistance method comprising:
determining an assignment area for each of a plurality of articles in an object area in which the articles are placed by at least one processor; and
determining a layout of constituent elements of the article in the assignment area by the at least one processor.

8. A non-transitory storage medium storing a layout assistance program causing a computer to carry out:
an area determination process of determining an assignment area for each of a plurality of articles in an object area in which the articles are placed; and
an element layout determination process of determining a layout of constituent elements of the article in the assignment area.
